(19) United States
(12) Patent Application Publication
(10) Pub. No.: US 2011/0288830 A1
(43) Pub. Date: Nov. 24, 2011

(54) Finite State Machine Diagram Generation

(76) Inventors: Bikram Garg, Patiala (IN); Manish Khanna, Agra (IN)

(21) Appl. No.: 12/856,579

(22) Filed: Aug. 13, 2010

Related U.S. Application Data
(60) Provisional application No. 61/233,497, filed on Aug. 13, 2009.

(51) Int. Cl. G06F 17/50

(52) U.S. Cl. 703/2

(57) ABSTRACT

A method for processing machine information of a system, such as an integrated circuit design, to generate a display of a finite state machine diagram by determining a position for the states in the diagram and then showing representations of the transitions between states to create a symmetrical, compact and cyclic process view of the finite state machine. Levels are assigned to the states in a first direction. A rule based technique then is used to order the states in levels that ensure minimum crossings of transitions between consecutive levels as well as for transitions in a same level. Next, the specific position of each state in a second direction orthogonal to the first direction is computed, such that the positions take into account areas or “tracks” in which connection lines representing transitions between states will be rendered. The connection line representing transitions between states are then rendered in the diagram.

### RELATED APPLICATIONS

This application claims priority to U.S. Provisional Patent Application No. 61/233,497, entitled “Finite State Machine Diagram Generator,” filed on Aug. 13, 2009, and naming Bikram Garg as inventor, which application is incorporated entirely herein by reference.

### FIELD OF THE INVENTION

The present invention is directed to the generation of a display of the possible states in a finite state machine. Various implementations of the invention may be particularly suitable for generating a display of the states in a finite state machine that shows the states in a symmetrical and compact cyclic process view with minimum crossing of edges representing state transitions.

### BACKGROUND OF THE INVENTION

A finite state machine is a mathematical construct that can be used to model the operation of a wide variety of different systems. A finite state machine is made up of a finite number of conditions or “states,” and the transitions between those states (i.e., from one condition to another condition) that occur in a specified order when specified criteria is met. The finite state machine “operates” by transitioning from an initial state to one or more different states. Finite-state machines are used to model systems in a large number of technologies, including electronic design automation. For example, finite state machines often are used to model the operation of a circuit design, to ensure that the design will perform the desired functions in response to the appropriate input signals.

While a finite state machine can be a useful tool to model a system such as an electronic circuit, it is sometimes difficult for the person using the finite state machine to comprehend its potential operation if it is large or complex. Accordingly, it is often useful for a user to generate a visual display diagramming some or all of the states in a finite state machine along with the transitions between those states. Even such a visual display of a finite state machine diagram may be difficult for a user to comprehend, however, if the states and the transitions between the states are rendered in a confusing manner.

### BRIEF SUMMARY OF THE INVENTION

Aspects of the invention relate to a method for processing machine information of a system, such as an integrated circuit design, to generate a display of a finite state machine diagram by determining a position for the states in the diagram and then showing representations of the transitions between states to create a symmetrical, compact and cyclic process view of the finite state machine. According to various implementations of the invention, a breadth-first-search based technique is used to assign rough levels to the states in a first direction (e.g., a position along an x-direction in a Cartesian coordinate system). A rule based technique then is used to order the states in levels that ensure minimum crossings of transitions between consecutive levels as well as for transitions in a same level. Next, the specific position of each state in the first direction and a second direction orthogonal to the first direction (e.g., the y-direction in a Cartesian coordinate system) is computed, such that the positions take into account areas or “tracks” in which connection lines representing transitions between states will be rendered. The connection line representing transitions between states are then rendered in the diagram.

### BRIEF DESCRIPTION OF THE DRAWINGS

FIG. 1 illustrates an example of a computing device that may be employed to implement various embodiments of the invention.

### DETAILED DESCRIPTION OF THE INVENTION

### Overview

A finite state machine is made up of a finite set of states and a finite set of possible transitions between these states. A corresponding state transition graph can be defined by the graph G=(S, T), where s [symbol] S and t (s1, s2) [symbol] T represents a directed edge (or arc) between the states s1 and s2. A start state s [symbol] S represents the finite state machine's initial state. The process for rendering a diagram for a finite state machine according to various implementations of the invention may include the following steps:
Assigning a level to the states along a first direction;
Ordering the states within each level;
Computing the positions of the states along a second direction orthogonal to the first direction;
Creating areas or “tracks” along which lines representing transitions between states in a same level will be rendered;
Computing specific positions of the states along the first direction;
Computing specific positions for rendering transitions lines representing transitions between states; and
Rendering representations of the states and the lines representing transitions between the states.

The above process ensures that the state transition diagram for a finite state machine is symmetrical, with short edges and minimizing edge crossings as well as edge overlapping in a cyclic process view.

### Operating Environment

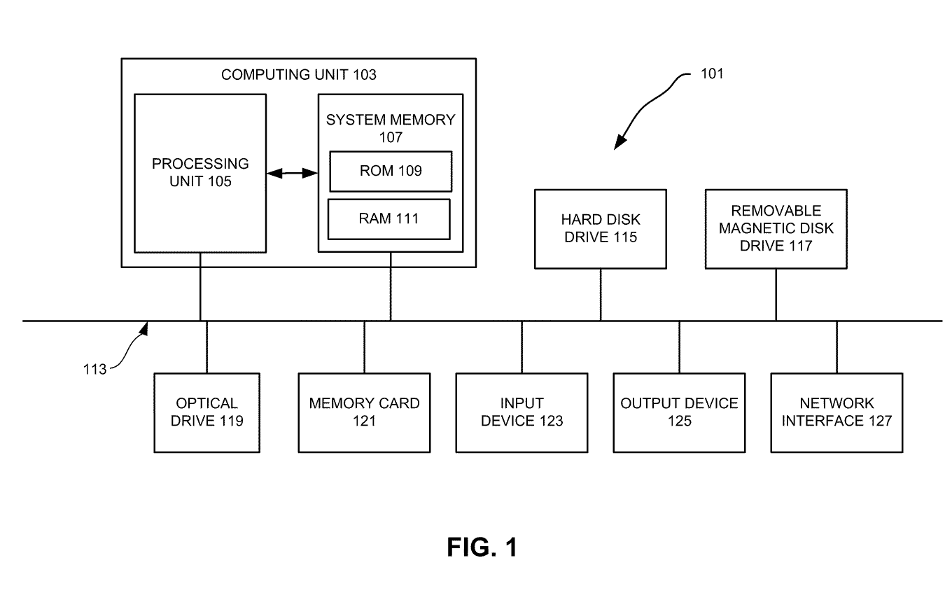

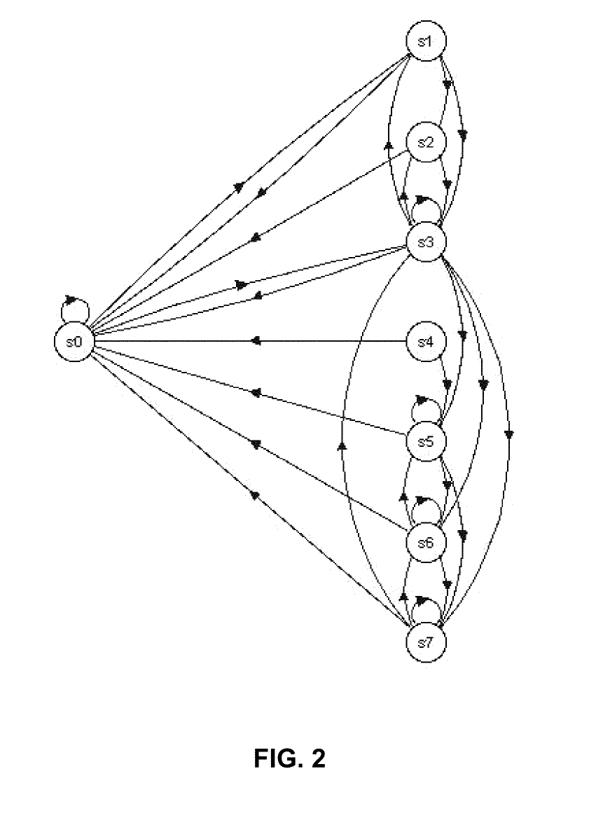

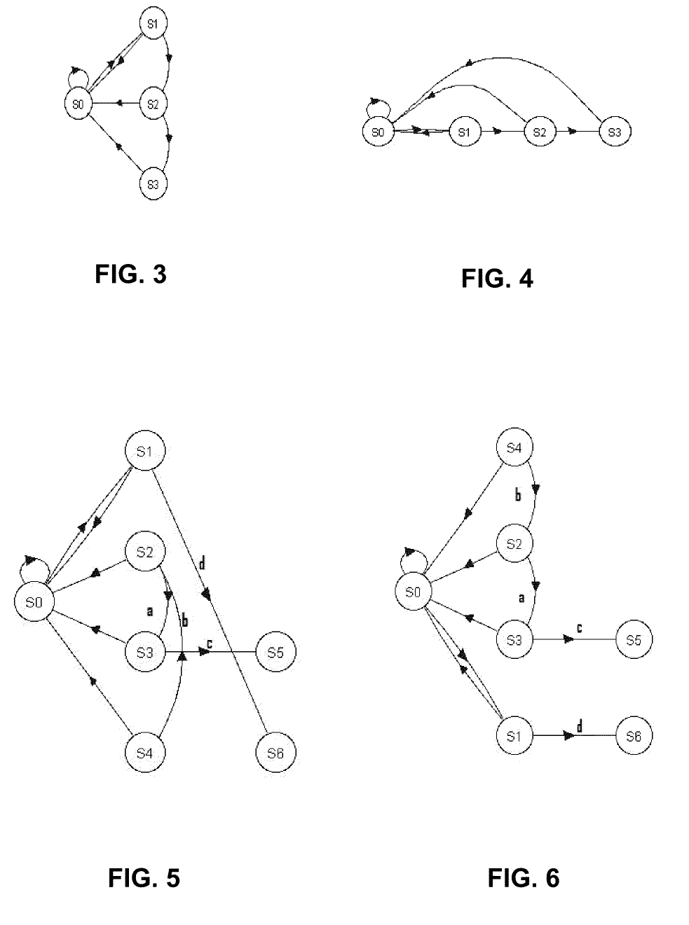

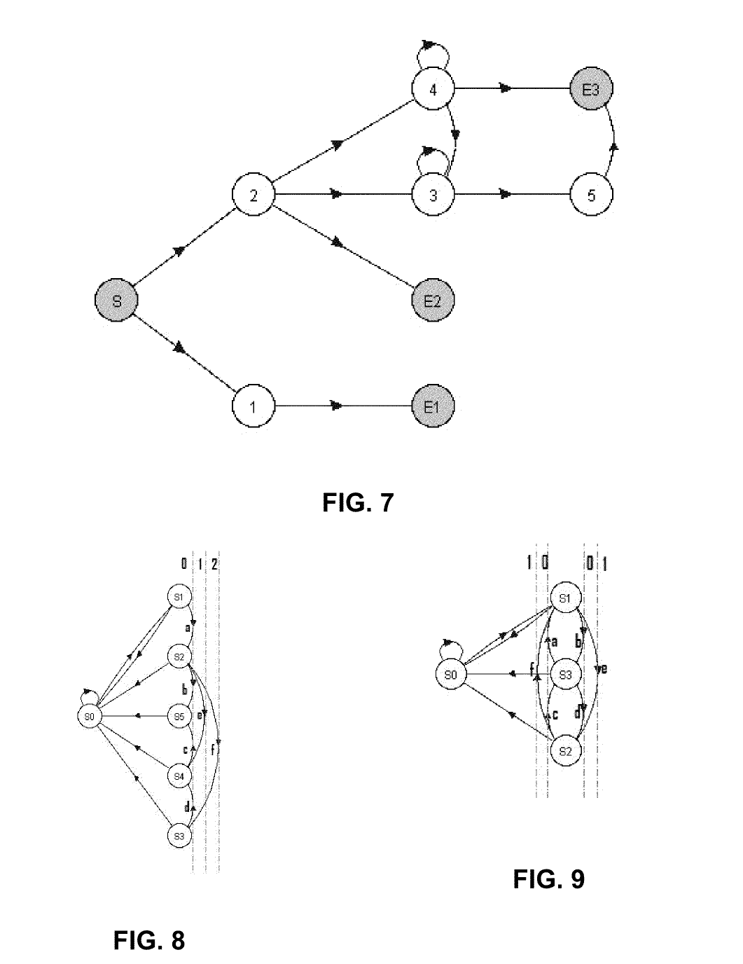

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Level Assignment

Initially, a level is assigned to the states that will be rendered in the display of the finite state machine diagram. The start state is assigned a level “zero.” The remaining states then each are assigned a positive discrete value that indicates their position relative to the start state. This creates a cyclic process view which eliminates any long forward or backward transitions in the diagram, since each state is positioned at most one level away from the connected state. This strategy is similar to a standard Breadth First Search. For example, referring now to FIG. 2, the start state s0 is assigned as level 0 and all states connected to s0 as level 1. If, in a simulation cycle the current state is s1 and a reset signal arrives, the transition will occur back to the start state s0. It can be seen that the edge showing the transition between states extends either in a same level or between adjacent levels, since states having transitions between them are either placed in same level or in adjacent level.

Various implementations of the invention may be particularly useful for generating and displaying a diagram for a finite state machine extracted from an integrated circuit design, because many of these types of finite state machines includes a reset signal which brings the control from any state back to the start state. A different approach can be used where states are assigned levels equal to the length of shortest path from the start state, but this may unnecessarily create long transitions that may be more difficult to comprehend for large finite state machines. A simple example of a 4-state counter as shown in FIGS. 3 and 4 highlights the difference in the two approaches.

### Ordering Algorithm

The second step is to order the states in a level (e.g., along a first direction, such as an x-direction in a Cartesian coordinate environment). The states in each level are ordered to minimize the number of crossovers of edges and reduce the edge length. There are three types of crossovers among edges. Firstly there can be a crossover between edges going in adjacent levels as shown in FIG. 5, where there is a crossover between edges c and d. Secondly there can be a crossover between edges in same level, for example, the crossover between edges a and b. Thirdly, there may be a crossover between edges in a same level and edges in a different level, as shown in FIG. 5 where there is a crossover between edges b and c.

In the finite state machine diagram illustrated in FIG. 5, all three types of crossings are illustrated, as previously noted. Upon completion of the ordering operation on the same input set as illustrated for the finite state machine diagram of FIG. 5, a finite state machine diagram is generated which eliminates all of the crossovers and minimizes the edge lengths, as shown in FIG. 6.

With various implementations of the invention, a recursive min-cut bisection algorithm can used to sort the states. For example, a variation of the Kernighan-Lin-Fiduccia-Mattheyses (KLFM) can be used to compute a bisection of the edges while minimizing the number of edge crossings. The difference between the conventional KLFM algorithm and the algorithm implemented according to various examples of the invention is that the algorithm implemented according to various examples of the invention minimizes all three types of the previously-mentioned edge crossovers. More particularly, the states can be ordered using a recursive routine that performs a min-cut sort and bisection of the set of states. The result of the bisection should be a pair of partitions. After the bisection is computed, this routine calls itself on each of the two partitions.

### Vertical Positioning

Next, positions are assigned to each of the states in a second direction orthogonal to the first direction (e.g., along a y-direction in a Cartesian coordinate system). The “vertical” position is assigned to all of the states within their assigned levels to minimize the edge length and create a symmetrical view. This step ensures that the view size does not increase arbitrarily in order to maintain symmetry and that the view is always clean and compact. Also, the position of the state obeys the ordering determined by the previous step. For example, as shown in FIG. 7 the state S is placed at Y position which is the mean of the Y-position of the states 1 and 2 to which state S is connected. Similarly state 2 is placed at the Y position which is the mean of the Y position of states 4, 3 and E2.

The assignment of position values (e.g., y-coordinates) to the states can be formulated as a set of linear constraints and an objective function involving absolute values to be minimized. There is a standard technique for transforming this optimization problem into linear program by introduction of extra variables, allowing the coordinates to be computed by standard procedures such as simplex method. Although this technique is practical for some graphs, it takes undesirable amount of time and memory to solve for y coordinates in other graphs. Accordingly, various implementations of the invention may employ an alternate technique of finding y-coordinate values to create a symmetrical and compact view.

The alternate technique first finds the level which has maximum number of states. It then places the states of the max level in order as determined from the previous step with a minimum separation between them. For example, in FIG. 7 the states 4, 3, E2 and E1 are placed first with a minimum separation between them. Then the states of at level less than and greater than max level are placed. So state 2 is placed by finding the mean of the position of states 4, 3 and E2. A collision can occur between states when they are being placed. A collision will occur if the separation between states is less than the minimum separation constraint, or if a state is placed above another state such that ordering determined from the previous level gets violated.

To remove a collision a shift in Y position is calculated such that collision can be avoided. This shift is then back-propagated to the previous placed state until the states in the max level. After finding the Y position for all the states, the exact position of the states is updated considering the shift associated with the states. The algorithm also tries to straighten the edges where ever possible.

### Track Assignment

Next, the track for the edges between states that are in same level are assigned, and thus the width between two adjacent levels. A track is a vertical tangent to the arc of the edge. For example an edge having a track zero is drawn as an arc having a tangent at track zero, and an edge on track 1 is drawn as an arc having tangent at track 1. For example in FIG. 8, the edge a, b, c, d lies on track 0, edge e lies on track 1 and edge f lies on track 2. The edges b, c does not overlap with edges e and f, the edges d, e do not overlap with edge f. The association of tracks with the edges ensures that there is no overlapping among edges in the same level. Also if there is a two way communication between two states i.e. there is a transition from state s1 to state s2 and vice versa and both these states are in the same level, then tracks are created on both sides of the level. For example, in FIG. 9, there is a two way transition between s1, s2, s3. Therefore tracks are created on both sides of the level thereby assigning track 0 to edge a and edge b, track 0 to edge c and edge d, and track 1 to edge e and edge f. By doing this the overlapping of paired edges is avoided. Also the paired edges are assigned same track number thereby maintaining symmetry in the view.

The algorithm is a variation of the Yoshimura and Kuh left edge algorithm which assumes that an edge occupies a single track and that an edge with a non intersecting Y range may share the same track. For the finite state machine diagram, there are three types of scenarios:
1) Edges with non-intersecting Y range may share same track.
2) Edges with intersecting Y range may share same track.
3) Edge having a subset of Y range cannot share same track with its superset edge.

The edge list is divided in two sets such that paired edges are not present in the same set. For example for FIG. 9 we have the following two sets of edge list.

eI={b,d,e}

eII={a,c,f}

The track assignment algorithm runs on the edge set that has maximum number of edges. Since in this example both the edge set have same number of edges, so any set can be chosen. A vertical constraint graph is constructed for the edge list in the edge set such that the edge having maximum Y range is at the top and edge whose Y range is the subset of other edge is placed as a child node of the bigger edge. The edges that have intersecting as well as non-intersecting Y range are placed at the same level of the graph. The bottom most edges are assigned track 0, and the parent edge is assigned track one more than the child node. After each node in the edge list is assigned a track, then the corresponding paired edge in other edge list is also assigned the same track.

### Horizontal Positioning

Next, the horizontal position of the levels is computed. States thus are given the same position as that of the level in which they are present. There is a minimum distance maintained between two consecutive levels. An additional spacing between consecutive levels is required when we have tracks presents between levels. A fixed spacing is added between levels for each track present between them.

### Edge Generation

Nest, the positions of the edges (i.e., the lines representing the transitions between states) are computed. There are four types of edges:
Direct Edges: Edges between adjacent levels, which may be illustrated with straight lines.
Paired Edges: Edges between adjacent levels connecting same states, which may be illustrated as arced lines.
Self Edges: Edges going to the same state showing a self-loop; shown as arc.
Same Level Edges: Edges between states in the same level; shown as arc.

The Direct edges are drawn such that if the edge is extended imaginarily it will pass through the center points of the states it is connecting to. The Paired Edges are drawn such that they have a fixed separation between them at the middle part and almost negligible separation at the ends with minimum edge length. The Self edge is drawn above a state as a circle with radius at a fixed distance above the state. The portion of the circle going inside the state is not drawn. The Same Level edges are drawn such that the track acts as a tangent to the arc drawn for the edge. The point on the circumference of a state is chosen such the length of the arc is a minimum.

Once the positions of the states have been determines and the coordinates for the edges representing the transitions between the states, then the diagram can be rendered using this information. The states may be represented by, e.g., rendering labeled circles in a computer monitor display (such as the output device 125), as shown in FIGS. 1-9. Similarly, the edges representing transitions between the states can be rendered using straight or arced lines, as also shown in FIGS. 1-9.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

1. A computer implemented method for generating a finite state machine diagram, comprising;
accessing state machine information of an integrated circuit design to define a state machine including a start state, a finite set of subsequent states and a finite set of possible transitions between these states; and
arranging the states in a way to generate a symmetrical, compact and cyclic process view with minimum crossings and showing transitions as edges between states.

2. The computer implemented method recited in claim 1, further comprising:
assigning an initial level to the start state, and
assigning levels to the subsequent states as a positive discrete value that indicates their position relative to the start state.

3. A computer implemented method for generating a finite state machine diagram, comprising:
assigning a level value to the states of a finite state machine, the level values corresponding to first positions arranged in a first direction;
for each level,
assigning an order to each state within the level, and
based upon the assigned orders, determining second positions of the states along a second direction orthogonal to the first direction;
rendering representations of the states at the first and second positions; and
rendering lines representing transitions between the states.

4. The method recited in claim 3, further comprising creating tracks along which lines representing transitions between states in a same level are rendered.

5. The method recited in claim 3, further comprising:
assigning a first level value to a start state, and
assigning a positive discrete level value to the remaining states based upon positions of the remaining states relative to the start state.

6. The method recited in claim 3, further comprising:
assigning a first level value to a start state, and
assigning a positive discrete level value to the remaining states based upon a length of a transition path from each remaining state to the start state.

7. The method recited in claim 3, further comprising ordering the states within a level along the second direction to minimize crossover of lines representing transitions between states and reduce a length of the lines representing transitions between states.

8. The method recited in claim 3, wherein the ordering employs a variation of the Kernighan-Lin-Fiduccia-Mattheyses ordering algorithm that minimizes crossovers between the lines representing transitions between states.

9. The method recited in claim 3, further comprising determining the second positions of the states in a level along the second direction so as to minimize a length of the lines representing transitions between states and create a symmetrical view of the rendered representations of the states.

10. The method recited in claim 9, wherein the second positions of states within a level along the second direction are determined by
formulating the second positions as a set of linear constraints of an objective function, and
calculating a minimization of the function.

11. The method recited in claim 9, wherein the second positions of states within a level along the second direction are determined by
identifying a maximum level containing the largest number of states,
positioning the states with a minimum separation therebetween along the second direction; and
positioning states for other levels relative to the second positions of the states in the maximum level.
